(19) United States
(12) Patent Application Publication
(10) Pub. No.: US 2020/0112756 A1
(43) Pub. Date: Apr. 9, 2020

(54) CONTENT DATA RECOMMENDATION METHOD AND APPARATUS BASED ON IDENTITY VERIFICATION APPARATUS, AND STORAGE MEDIUM

(71) Applicant: SHENZHEN SENSETIME TECHNOLOGY CO., LTD., SHENZHEN (CN)

(72) Inventors: Li XU, SHENZHEN (CN); Miaoran XU, SHENZHEN (CN); Zhongfu ZHANG, SHENZHEN (CN); Yi LIU, SHENZHEN (CN); Yifan DIAO, SHENZHEN (CN)

(73) Assignee: SHENZHEN SENSETIME TECHNOLOGY CO., LTD., SHENZHEN (CN)

(21) Appl. No.: 16/706,761

(22) Filed: Dec. 8, 2019

Related U.S. Application Data
(63) Continuation of application No. PCT/CN2018/105113, filed on Sep. 11, 2018.

(30) Foreign Application Priority Data
Sep. 21, 2017 (CN) 201710862046.8

(51) Int. Cl. H04N 21/25; H04N 21/258; H04N 21/418; G06F 21/12

(52) U.S. Cl. CPC H04N 21/251; G06F 21/123; H04N 21/4182; H04N 21/25875

(57) ABSTRACT

A content data recommendation method based on an identity verification apparatus includes: in response to an operation for identity verification, obtaining a first image of a user, and obtaining attribute information of the user from the first image; sending the attribute information to a content server, so that the content server determines first recommendation content data of the user according to the attribute information; and receiving the first recommendation content data fed back by the content server, and displaying recommendation content corresponding to the first recommendation content data.

### CROSS-REFERENCE TO RELATED APPLICATIONS

The present application is a continuation of International Application No. PCT/CN2018/105113 filed on Sep. 11, 2018, which claims priority to Chinese Patent Application No. 201710862046.8 filed on Sep. 21, 2017. The disclosures of these applications are hereby incorporated by reference in their entirety.

### BACKGROUND

With the development of commercial society, commodities become increasingly rich, and the advertising of commodities also occurs everywhere. However, in modern society, information rapidly increases, so that people have no interest in an extremely great amount of advertisements. People fail to quickly find, from numerous advertisements, commodity advertisements related thereto.

A person-identity document comparison apparatus is increasingly widely applied in life, for example, Telecom Business Hall, banks, Internet cafes, hotels, and other places. When people conduct businesses in these places, person and identity document comparison needs to be performed first. The existing person-identity document comparison apparatus has only detection and recognition functions, and does not have any other media pushing function. While during person and identity document comparison, a user needs to stay for a period of time in front of the apparatus and also needs to look forward. While there is no information displayed in front, and there is further no commercial information displayed. In this case, as nothing can cause the concern of people, the people would feel dull and boring.

### SUMMARY

The present disclosure relates to the technical field of information processing, and in particular to a content data recommendation method and apparatus based on an identity verification apparatus, and a storage medium.

Embodiments of the present disclosure aim to provide technical solutions for content data recommendation based on an identity verification apparatus.

According to a first aspect of one or more embodiments of the present disclosure, provided is a content data recommendation method based on an identity verification apparatus. The method includes: in response to an operation for identity verification, obtaining a first image of a user, and obtaining attribute information of the user from the first image; sending the attribute information to a content server, so that the content server determines first recommendation content data of the user according to the attribute information; and receiving the first recommendation content data fed back by the content server, and displaying recommendation content corresponding to the first recommendation content data.

According to a second aspect of whether glasses are worn embodiments of the present disclosure, provided is a content data recommendation method based on an identity verification apparatus. The method includes: receiving attribute information of a user sent by a terminal device; determining first recommendation content data of the user according to the attribute information; and pushing the first recommendation content data to the terminal device.

According to a third aspect of one or more embodiments of the present disclosure, provided is a content data recommendation apparatus based on an identity verification apparatus. The apparatus includes: a first obtaining module, configured to, in response to an operation for identity verification, obtain a first image of a user, and obtain attribute information of the user from the first image; a first sending module, configured to send the attribute information obtained by the first obtaining module to a content server, so that the content server determines first recommendation content data of the user according to the attribute information; and a first receiving module, configured to receive the first recommendation content data fed back by the content server, and display recommendation content corresponding to the first recommendation content data.

According to a fourth aspect of one or more embodiments of the present disclosure, provided is a content data recommendation apparatus based on an identity verification apparatus. The content data recommendation apparatus includes: a memory storing processor-executable instructions; and a processor arranged to execute the stored processor-executable instructions to perform steps of: in response to an operation for identity verification, obtaining a first image of a user, and obtain attribute information of the user from the first image; sending the attribute information obtained by the first obtaining module to a content server, so that the content server determines first recommendation content data of the user according to the attribute information; and receiving the first recommendation content data fed back by the content server, and displaying recommendation content corresponding to the first recommendation content data.

According to a fifth aspect of one or more embodiments of the present disclosure, provided is a content data recommendation apparatus based on an identity verification apparatus. The apparatus includes: a fourth receiving module, configured to receive attribute information of a user sent by a terminal device; a first determining module, configured to determine first recommendation content data of the user according to the attribute information received by the fourth receiving module; and a fourth sending module, configured to push the first recommendation content data determined by the first determining module to the terminal device.

According to a sixth aspect of one or more embodiments of the present disclosure, provided is a computer-readable storage medium, having computer program instructions stored thereon, where when the program instructions are executed by a processor, steps of the content data recommendation method based on an identity verification apparatus according to the first aspect of the embodiments of the present disclosure are implemented; or when the program instructions are executed by a processor, steps of the content data recommendation method based on an identity verification apparatus according to the second aspect of the embodiments of the present disclosure are implemented.

According to a seventh aspect of one or more embodiments of the present disclosure, provided is a computer program product, having computer program instructions stored thereon, where when the program instructions are executed by a processor, steps of the content data recommendation method based on an identity verification apparatus according to the first aspect of the embodiments of the present disclosure are implemented; or when the program instructions are executed by a processor, steps of the content data recommendation method based on an identity verification apparatus according to the second aspect of the embodiments of the present disclosure are implemented.

According to an eighth aspect of one or more embodiments of the present disclosure, provided is an electronic device, including a first processor, a first memory, a first communication element, and a first communication bus, where the first processor, the first memory, and the first communication element communicate with each other by means of the first communication bus; and the first memory is configured to store at least one executable instruction, and the executable instruction causes the first processor to execute steps of the content data recommendation method based on an identity verification apparatus according to the first aspect of the embodiments of the present disclosure.

According to a ninth aspect of one or more embodiments of the present disclosure, provided is an electronic device, including a second processor, a second memory, a second communication element, and a second communication bus, where the second processor, the second memory, and the second communication element communicate with each other by means of the second communication bus; and the second memory is configured to store at least one executable instruction, and the executable instruction causes the second processor to execute steps of the content data recommendation method based on an identity verification apparatus according to the second aspect of the embodiments of the present disclosure.

### BRIEF DESCRIPTION OF DRAWINGS

FIG. 1 is a flowchart of a content data recommendation method based on an identity verification apparatus according to Embodiment I of the present disclosure;

FIG. 2 is a flowchart of a content data recommendation method based on an identity verification apparatus according to Embodiment II of the present disclosure;

FIG. 3 is a flowchart of a content data recommendation method based on an identity verification apparatus according to Embodiment III of the present disclosure;

FIG. 4 is a flowchart of a content data recommendation method based on an identity verification apparatus according to Embodiment IV of the present disclosure;

FIG. 5 is a schematic structural diagram of a content data recommendation apparatus based on an identity verification apparatus according to Embodiment V of the present disclosure;

FIG. 6 is a schematic structural diagram of a content data recommendation apparatus based on an identity verification apparatus according to Embodiment VI of the present disclosure;

FIG. 7 is a schematic structural diagram of a content data recommendation apparatus based on an identity verification apparatus according to Embodiment VII of the present disclosure;

FIG. 8 is a schematic structural diagram of a content data recommendation apparatus based on an identity verification apparatus according to Embodiment VIII of the present disclosure;

FIG. 9 is a schematic structural diagram of a content data recommendation apparatus based on an identity verification apparatus according to Embodiment IX of the present disclosure;

FIG. 10 is a schematic structural diagram of a content data recommendation apparatus based on an identity verification apparatus according to Embodiment X of the present disclosure;

FIG. 11 is a schematic structural diagram of an electronic device according to Embodiment XI of the present disclosure; and

FIG. 12 is a schematic structural diagram of an electronic device according to Embodiment XII of the present disclosure.

### DETAILED DESCRIPTION

The specific implementations of the embodiments of the present disclosure are further described in detail below with reference to the accompanying drawings (the same reference numerals in a plurality of accompanying drawings represent the same elements) and some embodiments. The following embodiments are intended to illustrate the present disclosure, but are not intended to limit the scope of the present disclosure.

A person skilled in the art may understand that the terms such as “first” and “second” in the embodiments of the present disclosure are only used to distinguish different steps, devices or modules, etc., and do not represent any specific technical meaning or an inevitable logical sequence therebetween.

### Embodiment I

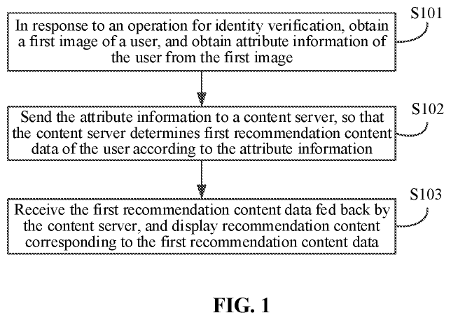

FIG. 1 is a flowchart of a content data recommendation method based on an identity verification apparatus according to embodiment I of the present disclosure. As shown in FIG. 1, the content data recommendation method based on an identity verification apparatus according to the present embodiment includes the following steps.

In step S101, in response to an operation for identity verification, a first image of a user is obtained, and attribute information of the user is obtained from the first image.

The first image may be a video image in a video frame sequence. Specifically, the first image may include a head image of the user. The attribute information includes at least one of: skin color, hairstyle, whether glasses are worn, whether jewelry is worn, gender, age, hair color, or whether makeup is worn. The identity verification apparatus is an electronic device having an identity verification function.

In one embodiment, the attribute information of the user may be obtained from the first image of the user based on a deep learning method. It may be understood that the embodiments of the present disclosure are not limited to obtaining the attribute information of the user from a user image by using the deep learning method, and any method that may obtain the attribute information of the user from the user image is applicable thereto.

In step S102, the attribute information is sent to a content server, so that the content server determines first recommendation content data of the user according to the attribute information.

The content server may be a server having an advertisement distribution function, and the first recommendation content data may be image data or video data including advertisement information and corresponds to the attribute information sent to the content server.

In step S103, the first recommendation content data fed back by the content server is received, and recommendation content corresponding to the first recommendation content data is displayed.

According to the content data recommendation method provided in the present embodiment, in response to an operation for identity verification, a user image is obtained, attribute information of a user is obtained from the user image, and the attribute information of the user is sent to a content server, so that the content server determines recommendation content data of the user according to the attribute information. Then, the recommendation content data fed back by the content server is received, and recommendation content corresponding to the recommendation content data is displayed. Thus, precise content data can be recommended to the user without interruption, the dull and boring feeling of the user in an identity verification process can be eliminated, and content data related to the user can also be obtained by using the waiting time of identity verification, thereby implementing maximization of a recommendation effect.

The content data recommendation method according to the present embodiment may be executed by any appropriate device having image or data processing capability, including, but not limited to, a camera, a terminal, a mobile terminal, a Personal Computer (PC), a server, a vehicle-mounted device, an entertainment device, an advertising device, a Personal Digital Assistant (PDA), a tablet computer, a laptop computer, a handheld game console, smart glasses, a smart watch, a wearable device, a virtual display device or a display enhanced device (such as Google Glass, Oculus Rift (a head-mounted display), Hololens (a holographic head-mounted display of Microsoft Corporation), Gear VR (a head-mounted display of Samsung Corporation), and the like.

### Embodiment II

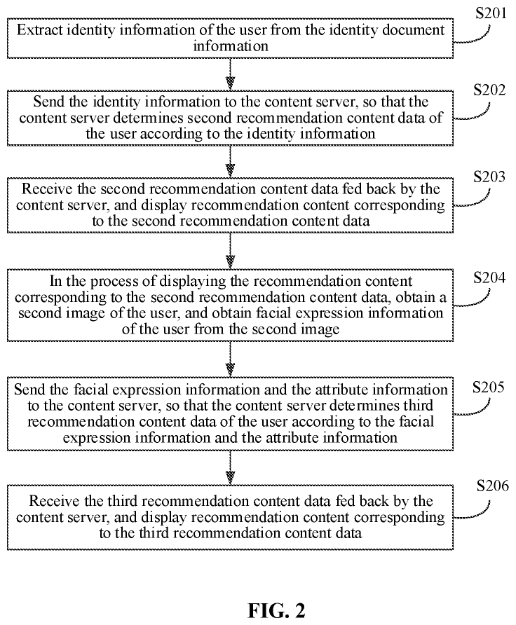

FIG. 2 is a flowchart of a content data recommendation method based on an identity verification apparatus according to Embodiment II of the present disclosure.

In one embodiment, by taking an electronic device having a face recognition function being used as an execution subject as an example, the content data recommendation method according to the present embodiment of the present disclosure is described. However, a person skilled in the art should understand that, in practical application, other execution subjects may implement corresponding content data recommendation operations with reference to the present embodiment.

As shown in FIG. 2, the content data recommendation method based on an identity verification apparatus according to the present embodiment includes the following steps.

In step S201, identity information of a user is extracted from identity document information.

Based on Embodiment I above, in a specific implementation, when obtaining the first image of the user, the method further includes: obtaining identity document information of the user; and performing identity verification according to the first image and the identity document information to obtain a result of the identity verification. After the identity document information of the user is obtained, identity information of the user is extracted from the identity document information.

In one embodiment of the present disclosure, the obtaining identity document information of the user includes: recognizing information in an identity document chip by means of a card reader, and obtaining identity document information of the user based on the information in the identity document chip. In another optional implementation of the present disclosure, the obtaining identity document information of the user includes: recognizing image information in an identity document image by means of an OCR module, and obtaining the identity document information of the user based on the image information. It may be understood that the embodiments of the present disclosure are not limited to recognizing the information in the identity document chip by means of the card reader or recognizing the image information in the identity document image by means of the OCR module to obtain the identity document information of the user. Any method used for obtaining the identity document information of the user is applicable to the embodiments of the present disclosure.

The identity verification may include comparison and verification of a real-time head image of the user and a user photo in an identity document to determine whether the image of the user is consistent with the photo in the identity document, so that the validity of the identity document of the user can be ensured. The identity document information of the user includes the identity information of the user and the photo in the identity document. Specifically, the photo in the identity document may be a photo in an identity card, a photo in a passport, or the like.

In one embodiment, similarity comparison between the head image in the first image of the user and the photo in the identity document is implemented by using a deep learning method, so as to implement real-name verification of the user and the identity document, thereby ensuring the validity of the identity document of the user. It may be understood that the embodiments of the present disclosure are not limited to implementing the similarity comparison between the first image of the user and the photo in the identity document by using the deep learning method, and any method that may implement the similarity comparison between the first image of the user and the photo in the identity document is applicable to the embodiments of the present disclosure.

The identity information includes at least one of: gender, age, registered residence, birth date, or astrological sign. The result of the identity verification may include real-name authentication success, real-name authentication failure, or real-person detection failure.

In scenes such as Internet cafes, business halls, and hotels, the electronic device having the face recognition function is placed on a service counter. When the user places the identity card on the position of the card reader of the electronic device, the electronic device instantly obtains information of the identity card, and obtains the identity information of the user from the information of the identity card.

In step S202, the identity information is sent to the content server, so that the content server determines second recommendation content data of the user according to the identity information.

The content server may be an advertisement distribution background. The second recommendation content data may be image data or video data including advertisement information and corresponds to the identity information sent to the content server. For example, the second recommendation content data may be an identifier, and actual recommendation content is stored in the local electronic device. The second recommendation content data may also be a specific advertisement video or image.

In step S203, the second recommendation content data fed back by the content server is received, and recommendation content corresponding to the second recommendation content data is displayed.

In one embodiment, the second recommendation content data corresponding to the identity information is received from the content server, and the second recommendation content data is displayed on a verification operation interface.

Specifically, the electronic device having the face recognition function sends the identity information of the user to the content server, and the second recommendation content data corresponding to the identity information is received from the content server. After the second recommendation content data is received, the second recommendation content data is displayed on the verification operation interface of the electronic device. When the second recommendation content data is an identifier, the electronic device selects, according to the identifier, corresponding recommendation content for display. When the second recommendation content data is a specific advertisement video or image, the electronic device extracts a recommendation video or image from the second recommendation content data, and then plays back or displays the recommendation video or image.

In one embodiment, first, face recognition-related presetting is performed on the electronic device, for example, ordinary detection or silent detection is selected as a face detection mode, and a maximum face recognition distance is set. Then, the electronic device accesses the advertisement distribution background, and the advertisement distribution background automatically pushes an advertisement to the electronic device according to the scene where the electronic device is located. When no person places an identity card on the electronic device, a display screen of the electronic device automatically plays back on a full screen a general advertisement provided by the advertisement distribution background. When a person places an identity card on the position of the card reader of the electronic device, the electronic device obtains identity information in the identity card and pushes the identity information to the advertisement distribution background, and the advertisement distribution background pushes a targeted advertisement to the electronic device according to gender, age, and registered residence in the identity information. For example, when the gender in the identity information is female, the age is 20 years old, and the registered residence is Beijing, the advertisement distribution background pushes an advertisement of a certain brand of lipstick to the electronic device. The targeted advertisement is played back, at the same time the camera of the electronic device is turned on to obtain the reaction of the user viewing the advertisement. Smile indicates like and indifferent expression indicates dislike. The facial reaction (facial expression information) of the user is uploaded to the advertisement distribution background as an optimization basis of subsequent advertisement distribution.

In step S204, in the process of displaying the recommendation content corresponding to the second recommendation content data, a second image of the user is obtained, and facial expression information of the user is obtained from the second image.

The second image may be a video image in a video frame sequence, and the second image may include a head image of the user. Specifically, the facial expression information may be a facial expression of the user.

In the process of displaying the second recommendation content data on the verification operation interface of the electronic device, the camera of the electronic device captures a user image, and the electronic device obtains the facial expression information of the user by using the deep learning method. It may be understood that the embodiments of the present disclosure are not limited to obtaining the facial expression information of the user from the user image by using the deep learning method, and any method that may obtain the facial expression information of the user from the user image is applicable thereto.

In step S205, the facial expression information and the attribute information are sent to the content server, so that the content server determines third recommendation content data of the user according to the facial expression information and the attribute information.

The attribute information includes at least one of: skin color, hairstyle, whether glasses are worn, whether jewelry is worn, gender, age, hair color, or whether makeup is worn. The third recommendation content data may be image data or video data including advertisement information and corresponds to the facial expression information and the attribute information sent to the content server. For example, the third recommendation content data may be an identifier, and actual recommendation content is stored in the local electronic device. The third recommendation content data may also be a specific advertisement video or image.

In step S206, the third recommendation content data fed back by the content server is received, and recommendation content corresponding to the third recommendation content data is displayed.

In one embodiment, after the third recommendation content data corresponding to the facial expression information and the attribute information is received from the content server, and the result of the identity verification is displayed, the recommendation content corresponding to the third recommendation content data is displayed. When the third recommendation content data is an identifier, the electronic device selects, according to the identifier, corresponding recommendation content for display. When the third recommendation content data is a specific advertisement video or image, the electronic device extracts a recommendation video or image from the third recommendation content data, and then plays back or displays the recommendation video or image.

In one embodiment, the displaying recommendation content corresponding to the third recommendation content data includes: on the verification operation interface, the third recommendation content data is displayed in the form of full screen. Specifically, on the verification operation interface of the electronic device, an advertisement recommended by the content server is displayed in the form of full screen. Thereby, a good display effect is achieved, the attention of the user can be drawn better, and the advertisement can also be displayed better.

After the verification operation interface of the electronic device displays the second recommendation content data, i.e., the targeted advertisement based on the identity information of the user is played back, the display screen of the electronic device displays a real-time video stream of the camera of the electronic device in a large area on the left side, and the display screen displays a photo, a name, and identity card number local information in an identity card in a small area on the right side. Then, the electronic device compares the user image captured by the camera from the real-time video stream with the photo in the identity card. Specifically, the electronic device compares the user image captured by the camera from the real-time video stream with the photo in the identity card by using the deep learning method. After comparison and verification are completed, the display screen of the electronic device displays the real-time video stream of the camera in a large area on the left side and a person-identity document comparison result in a small area on the right side for a period of time. After the person-identity document comparison result is displayed, the display screen of the electronic device plays back a precise advertisement on a full screen, and in this case, the precise advertisement is pushed by an advertisement distribution platform according to the attribute information of the user, such as the facial expression information, skin color, hairstyle, whether glasses are worn, and whether jewelry is worn. For example, during the playback of the targeted advertisement, an outdoor sporting goods advertisement is pushed to 20-year-old men with a short hair, who look happy, has dark skin, and do not wear glasses.

In one embodiment, steps S201 to S204 in the present embodiment may be described in the following way. Specifically, first, face recognition-related presetting is performed on the electronic device, for example, ordinary detection or silent detection is selected as a face detection mode, and a maximum face recognition distance is set. Then, the electronic device accesses the advertisement distribution background, and the advertisement distribution background automatically pushes an advertisement to the electronic device according to the scene where the electronic device is located. When no person places an identity card on the electronic device, a display screen of the electronic device automatically plays back on a full screen a general advertisement provided by the advertisement distribution background. When a person places an identity card on the card reader of the electronic device, the electronic device instantly obtains identity information and pushes the identity information to the advertisement distribution background, and the advertisement distribution background pushes a targeted advertisement to the electronic device according to gender, age, and registered residence in the identity information. In this case, the electronic device switches from playing back the general advertisement on a full screen to playing back the targeted advertisement on a full screen, and plays back the targeted advertisement for 3 seconds, for example, the gender in the identity information is female, the age is 20 years old, and the registered residence is Beijing, an advertisement of a certain brand of lipstick is pushed. The targeted advertisement is played back, at the same time the camera of the electronic device is turned on to obtain the facial expression information of the user, and the facial expression information and the attribute information of the user are transmitted to the advertisement distribution background in real time. The facial expression information of the user is the reaction of the user viewing the advertisement. Smile indicates like and indifferent expression indicates dislike. The facial expression information of the user may be uploaded to the advertisement distribution background as an optimization basis of subsequent advertisement distribution. In addition, the electronic device obtains the photo, the name, and the identity card number local information in the identity card of the user according to the obtained identity card image while the targeted advertisement is played back. Specifically, the process that the electronic device obtains the photo, the name, and the identity card number local information in the identity card of the user according to the identity card image needs a period of time, in general, 3 seconds, i.e., after the targeted advertisement is played back, the electronic device may obtain the photo, the name, and the identity card number local information in the identity card of the user. After the targeted advertisement is played back, the display screen displays the real-time video stream of the camera in a large area on the left side and the photo, the name, and the identity card number local information in the identity card of the user in a small area on the right side. Then, the electronic device compares the user image captured by the camera from the real-time video stream with the photo in the identity card. After comparison is completed, the display screen displays the real-time video stream of the camera in a large area on the right side and a person-identity document comparison result in a small area on the right side for 5 seconds. After the person-identity document comparison result is displayed, the display screen of the electronic device plays back a precise advertisement on a full screen, and in this case, the precise advertisement is pushed by an advertisement distribution platform according to the obtained facial expression information and attribute information of the user. For example, during the playback of the targeted advertisement, an outdoor sporting goods advertisement is pushed to 20-year-old men with a short hair, who look happy, has dark skin, and do not wear glasses, and the advertisement is played back for 10 seconds. After the precise advertisement is played back, the electronic device automatically switches from playing back the precise advertisement on a full screen to playing back a general advertisement on a full screen. The general advertisement is an advertisement played back when no person performs person-identity document comparison, and the precise advertisement is a targeted advertisement pushed to the user after the person-identity document comparison is performed.

According to the content data recommendation method provided in the present embodiment, in response to an operation for identity verification, identity document information of a user is obtained, identity information of the user is obtained from the identity document information, and the identity information of the user is sent to a content server, so that the content server determines second recommendation content data of the user according to the identity information. Then, the second recommendation content data fed back by the content server is received, and recommendation content corresponding to the second recommendation content data is displayed on a verification operation interface. Thus, targeted content data can be recommended to the user without interruption, the dull and boring feeling of the user in an identity verification process can be eliminated, and content data related to the user can also be obtained by using the waiting time of identity verification.

In addition, in the process of displaying the second recommendation content data on the verification operation interface, a user image is captured, and facial expression information of the user is obtained from the user image. Then, the facial expression information and the attribute information are sent to the content server, third recommendation content data corresponding to the facial expression information and the attribute information is received from the content server, and after a result of the identity verification is displayed, the third recommendation content data is displayed, so that content data can further be precisely recommended to the user without interruption according to the facial expression reaction to the second recommendation content data and the attribute information of the user, thereby implementing maximization of a recommendation effect.

The content data recommendation method according to the present embodiment is not limited to be executed by an electronic device having a face recognition function and may be executed by any appropriate device having image or data processing capability, including, but not limited to, a camera, a terminal, a mobile terminal, a PC, a server, a vehicle-mounted device, an entertainment device, an advertising device, a PDA, a tablet computer, a laptop computer, a handheld game console, smart glasses, a smart watch, a wearable device, a virtual display device or a display enhanced device (such as Google Glass, Oculus Rift, Hololens, or Gear VR), and the like.

### Embodiment III

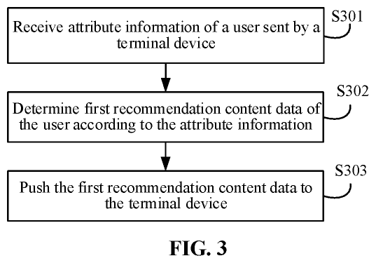

FIG. 3 is a flowchart of a content data recommendation method based on an identity verification apparatus according to Embodiment III of the present disclosure. As shown in FIG. 3, the content data recommendation method based on an identity verification apparatus according to the present embodiment includes the following steps.

In step S301, attribute information of a user sent by a terminal device is received.

In one embodiment, in response to an operation for identity verification, the terminal device captures a user image, and obtains attribute information of the user from the user image. After obtaining the attribute information of the user, the terminal device sends the attribute information of the user to a content server, and the content server receives the attribute information of the user sent by the terminal device. The content server may be a server having an advertisement distribution function, and the attribute information of the user includes at least one of: skin color, hairstyle, whether glasses are worn, whether jewelry is worn, gender, age, hair color, or whether makeup is worn. The identity verification apparatus is an electronic device having an identity verification function.

In step S302, first recommendation content data of the user is determined according to the attribute information.

In one embodiment, after receiving the attribute information of the user sent by the terminal device, the content server determines first recommendation content data according to the attribute information. Specifically, during the determination of first recommendation content data of the user according to the attribute information, the attribute information may be matched with index information of multiple pieces of recommendation content data separately; a matching score between the attribute information and the index information of each piece of recommendation content data is obtained by calculation based on a matching result; and the first recommendation content data is determined according to the matching score. The index information of each piece of recommendation content data may include at least one of: skin color information, hairstyle information, information about whether glasses are worn, information about whether jewelry is worn, gender information, age information, hair color information, or information about whether makeup is worn.

For example, the attribute information of user A is dark skin, short hair, no glasses or jewelry on, and then dark skin information, short hair information, and information about no glasses or jewelry on of user A are matched with the skin color information, the hairstyle information, the information about whether glasses are worn, and the information about whether jewelry is worn in the recommendation content data respectively. If the skin color information in the recommendation content data includes the dark skin information, it is indicated that the dark skin information of user A matches the skin color information in the recommendation content data, and a corresponding matching score can be obtained. If the skin color information in the recommendation content data does not include the dark skin information, it is indicated that the dark skin information of user A does not match the skin color information in the recommendation content data, and a corresponding matching score cannot be obtained. Similarly, if the hairstyle information in the recommendation content data includes the short hair information, it is indicated that the short hair information of user A matches the hairstyle information in the recommendation content data, and a corresponding matching score can be obtained. Similarly, if the hairstyle information in the recommendation content data does not include the short hair information, it is indicated that the short hair information of user A does not match the hairstyle information in the recommendation content data, and a corresponding matching score cannot be obtained. If the information about whether glasses are worn in the recommendation content data is no glasses on, it is indicated that the information about no glasses on of user A matches the information about whether glasses are worn in the recommendation content data, and a corresponding matching score can be obtained. If the information about whether glasses are worn in the recommendation content data is information that glasses are worn, it is indicated that the information about no glasses on of user A does not match the information about whether glasses are worn in the recommendation content data, and a corresponding matching score cannot be obtained. If the information about whether jewelry is worn in the recommendation content data is no jewelry on, it is indicated that the information about no jewelry on of user A matches the information about whether jewelry is worn in the recommendation content data, and a corresponding matching score can be obtained. If the information about whether jewelry is worn in the recommendation content data is information that jewelry is worn, it is indicated that the information about no jewelry on of user A does not match the information about whether jewelry is worn in the recommendation content data, and a corresponding matching score cannot be obtained. Then, the matching scores of all items in the attribute information of user A are accumulated to obtain a matching score between the attribute information of user A and the index information of the recommendation content data. Finally, based on the matching score between the attribute information of user A and the index information of each piece of the recommendation content data, recommendation content data with a largest matching score is selected as the first recommendation content data. If there are two or more pieces of recommendation content data with the largest matching score (two or more pieces of recommendation content data have a same largest matching score), the content server randomly selects from the recommendation content data with the largest matching score one piece of recommendation content data as the first recommendation content data. The first recommendation content data may be image data or video data including advertisement information.

In step S303, the first recommendation content data is pushed to the terminal device.

In one embodiment, after determining first recommendation content data according to the attribute information, the content server pushes the first recommendation content data to the terminal device.

According to the content data recommendation method provided in the present embodiment, attribute information of a user sent by a terminal device is received; first recommendation content data is determined according to the attribute information of the user; and then the determined first recommendation content data is pushed to the terminal device. Thus, precise content data can be recommended to the user.

The content data recommendation method according to the present embodiment is not limited to be executed by a content server and may be executed by any appropriate device having image or data processing capability, including, but not limited to, a camera, a terminal, a mobile terminal, a PC, a server, a vehicle-mounted device, an entertainment device, an advertising device, a PDA, a tablet computer, a laptop computer, a handheld game console, smart glasses, a smart watch, a wearable device, a virtual display device or a display enhanced device (such as Google Glass, Oculus Rift, Hololens, or Gear VR), and the like.

### Embodiment IV

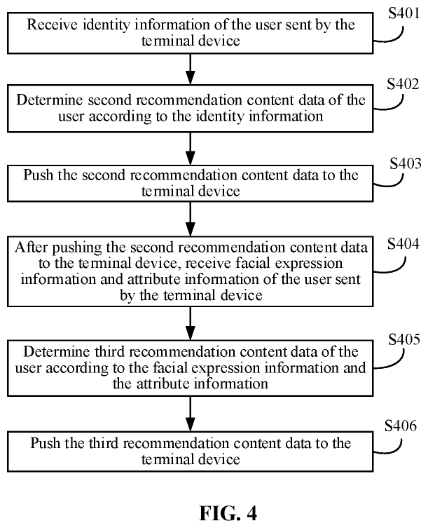

FIG. 4 is a flowchart of a content data recommendation method based on an identity verification apparatus according to Embodiment IV of the present disclosure. As shown in FIG. 4, the content data recommendation method based on an identity verification apparatus according to the present embodiment includes the following steps.

In step S401, identity information of a user sent by a terminal device is received.

In one embodiment, in response to an operation for identity verification, a terminal device obtains identity document information, and obtains identity information of a user from the identity document information. After obtaining the identity information of the user, the terminal device sends the identity information of the user to a content server, and the content server receives the identity information of the user sent by the terminal device. The content server may be a server having an advertisement distribution function, and the identity information of the user includes at least one of: gender, age, registered residence, birth date, or astrological sign.

In one embodiment, before receiving the identity information of the user sent by the terminal device, the content server receives identifier information sent by the terminal device, and determines a display duration and a content range of precise recommendation content data according to the identifier information of the terminal device. The identifier information may be a device code of the terminal device, and the device code identifies an application scene of the terminal device.

Specifically, after the terminal device accesses the content server, the content server determines, according to the identifier information of the terminal device, a scene where the terminal device is located, and a display duration and a content range of precise recommendation content data corresponding to the scene where the terminal device is located. For example, in an Internet cafe, after person and identity document comparison is performed, a precise advertisement such as a game advertisement is played back, and in a hotel check-in scene, after person and identity document comparison is performed, a precise advertisement such as a scenic spot advertisement is played back. The playback duration of the precise advertisement needs to be set in advance according to factors of an actual scene, such as stay and speed of people.

In step S402, second recommendation content data of the user is determined according to the identity information.

In one embodiment, after receiving the identity information of the user sent by the terminal device, the content server determines second recommendation content data according to the identity information. Specifically, during the determination of second recommendation content data of the user according to the identity information, the identity information may be matched with index information of multiple pieces of recommendation content data separately; a matching score between the identity information and the index information of each piece of recommendation content data is obtained by calculation based on a matching result; and the second recommendation content data is determined according to the matching score. The index information of each piece of recommendation content data may include at least one of: gender information, age information, registered residence information, skin color information, hairstyle information, information about whether glasses are worn, information about whether jewelry is worn, hair color information, or information about whether makeup is worn.

For example, when the gender in the identify information of user B is female, the age is 20 years old, and the registered residence is Beijing, information that the gender of user B is female, information that the age is 20 years old, and information that the registered residence is Beijing are matched with the gender information, the age information, and the registered residence information in the recommendation content data respectively. If the gender information in the recommendation content data includes female, it is indicated that the information that the gender of user B is female matches the gender information in the recommendation content data, and an obtained corresponding matching score is 0.3. If the gender information in the recommendation content data does not include female, it is indicated that the information that the gender of user B is female does not match the gender information in the recommendation content data, and an obtained corresponding matching score is 0. Similarly, if the age information in the recommendation content data includes 20 years old, it is indicated that the information that the age of user B is 20 years old matches the age information in the recommendation content data, and an obtained corresponding matching score is 0.4. If the age information in the recommendation content data does not include 20 years old, it is indicated that the information that the age of user B is 20 years old does not match the age information in the recommendation content data, and an obtained corresponding matching score is 0. If the registered residence information in the recommendation content data includes Beijing, it is indicated that the information that the registered residence of user B is Beijing matches the registered residence information in the recommendation content data, and an obtained corresponding matching score is 0.3. If the registered residence information in the recommendation content data does not include Beijing, it is indicated that the information that the registered residence of user B is Beijing does not match the registered residence information in the recommendation content data, and an obtained corresponding matching score is 0. Then, the matching scores of all items in the identity information of user B are accumulated to obtain a matching score between the identity information of user B and the index information of the recommendation content data. Finally, based on the matching score between the attribute information of user B and the index information of each piece of the recommendation content data, recommendation content data with a largest matching score is selected as the second recommendation content data. If two or more pieces of recommendation content data have a same largest matching score, the content server randomly selects from the recommendation content data with the largest matching score one piece of recommendation content data as the second recommendation content data. The second recommendation content data may be image data or video data including advertisement information.

For example, the gender in the identity information of user B is female, the age is 20 years old, and the registered residence is Beijing; the advertising range of a lipstick of brand 1 is that the gender is female, the age is 20-30, and the registered residence is a first-tier city such as Beijing, Shanghai, Guangzhou, or Shenzhen; and the advertising range of a lipstick of brand 2 is that the gender is female, the age is 20-30, and the registered residence is second-tier city such as Changsha, Hefei, or Shenyang. Then, the identity information of user B is matched with index information of two advertisements separately. According to the matching strategy, for the identity information of user B, the score of the lipstick of brand 1 is 0.3+0.4+0.3=1, the score of the lipstick of brand 2 is 0.3+0.4=0.7, and therefore, the advertisement of the lipstick of brand 1 with a highest score is pushed to user B.

In step S403, the second recommendation content data is pushed to the terminal device.

In one embodiment, after determining second recommendation content data according to the identity information, the content server pushes the second recommendation content data to the terminal device.

In step S404, after the second recommendation content data is pushed to the terminal device, facial expression information and attribute information of the user sent by the terminal device are received.

In one embodiment, after receiving the second recommendation content data pushed by the content server, the terminal device displays the second recommendation content data on its display screen. In the process of displaying the second recommendation content data, the camera of the terminal device is turned on to obtain an image of the user viewing the second recommendation content data, and obtain facial expression information of the user from the image. After obtaining facial expression information and attribute information of the user, the terminal device sends the obtained facial expression information and attribute information to a content server. The attribute information of the user may include: skin color, hairstyle, whether glasses are worn, whether jewelry is worn, gender, age, hair color, or whether makeup is worn, and the facial expression information is a facial expression of the user viewing the second recommendation content data.

In step S405, third recommendation content data of the user is determined according to the facial expression information.

In one embodiment, after receiving the facial expression information and the attribute information of the user sent by the terminal device, the content server determines third recommendation content data according to the facial expression information and the attribute information. Specifically, during the determination of the third recommendation content data according to the facial expression information and the attribute information, the type of the third recommendation content data may be determined according to the facial expression information; the attribute information is matched with index information of multiple pieces of recommendation content data of the determined type; a matching score between the attribute information and the index information of each piece of recommendation content data of the determined type is obtained by calculation based on a matching result; and the third recommendation content data is determined according to the matching score. The index information of each piece of recommendation content data may include gender information, age information, registered residence information, skin color information, hairstyle information, information about whether glasses are worn, information about whether jewelry is worn, hair color information, or information about whether makeup is worn.

The facial expression information is a facial expression of the user viewing the second recommendation content data. If the facial expression indicates a positive expression such as happiness, it is indicated that the type of recommendation content data is concerned and preferred by the user, and the release of the same type of recommendation content data will be subsequently continued; if the facial expression indicates a negative expression such as disgust, it is indicated that the type of recommendation content data is disliked by the user, and the release of the type of recommendation content data will not be subsequently continued. After the type of the third recommendation content data is determined according to the facial expression information of the user, the attribute information may be matched with index information of multiple pieces of recommendation content data of the determined type; a matching score between the attribute information and the index information of each piece of recommendation content data of the determined type is obtained by calculation based on a matching result; and the third recommendation content data is determined according to the matching score. The specific matching process is similar to that in step S302 in embodiment III, and details are not described herein repeatedly.

In one embodiment of the present disclosure, fourth recommendation content data may further be determined according to the identity information of the user obtained in step S401 and the facial expression information and the attribute information of the user obtained in step S404. Specifically, the type of the fourth recommendation content data may be determined according to the facial expression information; the attribute information is matched with index information of multiple pieces of recommendation content data of the determined type; a matching score between the attribute information and the index information of each piece of recommendation content data of the determined type is obtained by calculation based on a matching result; and the fourth recommendation content data is determined according to the matching score. The involved specific matching process is similar to that in step S302 in embodiment III, and details are not described herein repeatedly.

In step S406, the third recommendation content data is pushed to the terminal device.

In one embodiment, after determining third recommendation content data according to the attribute information and the facial expression information, the content server pushes the third recommendation content data to the terminal device.

According to the content data recommendation method provided in the present embodiment, identity information of a user sent by a terminal device is received; second recommendation content data of the user is determined according to the identity information of the user; and then the determined second recommendation content data is pushed to the terminal device. Thus, content data related thereto can be recommended to the user.

In addition, after the second recommendation content data is pushed to the terminal device, facial expression information and attribute information of the user sent by the user are received, third recommendation content data is determined according to the facial expression information and the attribute information of the user, and the determined third recommendation content data is pushed to the terminal device, so that precise content data related thereto can be recommended to the user.

The content data recommendation method according to the present embodiment is not limited to be executed by a content server and may be executed by any appropriate device having image or data processing capability, including, but not limited to, a camera, a terminal, a mobile terminal, a PC, a server, a vehicle-mounted device, an entertainment device, an advertising device, a PDA, a tablet computer, a laptop computer, a handheld game console, smart glasses, a smart watch, a wearable device, a virtual display device or a display enhanced device (such as Google Glass, Oculus Rift, Hololens, or Gear VR), and the like.

### Embodiment V

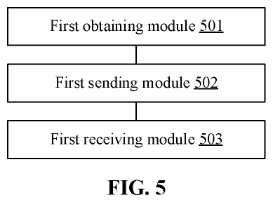

Based on a same technical concept, FIG. 5 is a schematic structural diagram of a content data recommendation apparatus based on an identity verification apparatus according to Embodiment V of the present disclosure. The flow of the content data recommendation method based on an identity verification apparatus according to Embodiment I may be executed.

With reference to FIG. 5, the content data recommendation apparatus includes a first obtaining module 501, a first sending module 502, and a first receiving module 503.

The first obtaining module 501 is configured to, in response to an operation for identity verification, obtain a first image of a user, and obtain attribute information of the user from the first image.

The first sending module 502 is configured to send the attribute information obtained by the first obtaining module 501 to a content server, so that the content server determines first recommendation content data of the user according to the attribute information.

The first receiving module 503 is configured to receive the first recommendation content data fed back by the content server, and display recommendation content corresponding to the first recommendation content data.

By means of the content data recommendation apparatus provided in the present embodiment, in response to an operation for identity verification, a user image is obtained, attribute information of a user is obtained from the user image, and the attribute information of the user is sent to a content server, so that the content server determines recommendation content data of the user according to the attribute information; and the recommendation content data fed back by the content server is received, and recommendation content corresponding to the recommendation content data is displayed. Thus, precise content data can be recommended to the user without interruption, the dull and boring feeling of the user in an identity verification process can be eliminated, and content data related to the user can also be obtained by using the waiting time of identity verification, thereby implementing maximization of a recommendation effect.

### Embodiment VI

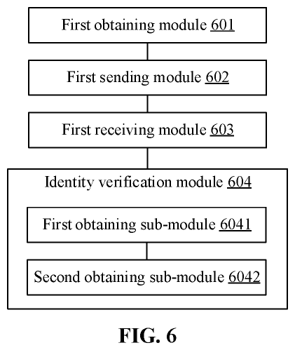

Based on a same technical concept, FIG. 6 is a schematic structural diagram of a content data recommendation apparatus based on an identity verification apparatus according to Embodiment VI of the present disclosure. The flow of the content data recommendation method based on an identity verification apparatus according to Embodiment II may be executed.

With reference to FIG. 6, the content data recommendation apparatus includes a first obtaining module 601, a first sending module 602, and a first receiving module 603. The first obtaining module 601 is configured to, in response to an operation for identity verification, obtain a first image of a user, and obtain attribute information of the user from the first image; the first sending module 602 is configured to send the attribute information obtained by the first obtaining module 601 to a content server, so that the content server determines first recommendation content data of the user according to the attribute information; and a first receiving module 603 is configured to receive the first recommendation content data fed back by the content server, and display recommendation content corresponding to the first recommendation content data.

In one embodiment, the apparatus further includes: an identity verification module 604, configured to, when the first obtaining module 601 obtains the first image of the user, obtain identity document information of the user; and perform identity verification according to the first image and the identity document information to obtain a result of the identity verification.

In one embodiment, the identity verification module 604 includes: a first obtaining sub-module 6041, configured to recognize information in an identity document chip by means of a card reader, and obtain the identity document information of the user based on the information in the identity document chip.

In one embodiment, the identity verification module 604 includes: a second obtaining sub-module 6042, configured to recognize image information in an identity document image by means of an OCR module, and obtain the identity document information of the user based on the image information.

It should be noted that, the specific details further involved in the content data recommendation apparatus based on an identity verification apparatus provided in the embodiments of the present disclosure are described in detail in the content data recommendation method based on an identity verification apparatus provided in the embodiments of the present disclosure, and details are not described herein repeatedly.

### Embodiment VII

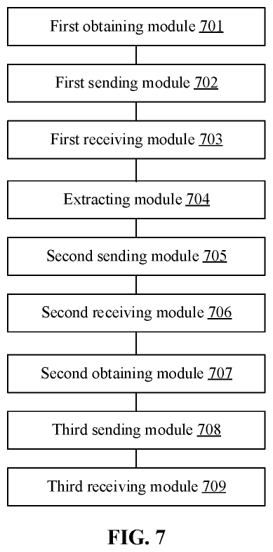

Based on a same technical concept, FIG. 7 is a schematic structural diagram of a content data recommendation apparatus based on an identity verification apparatus according to Embodiment VII of the present disclosure. The flow of the content data recommendation method based on an identity verification apparatus according to Embodiment II may be executed.

With reference to FIG. 7, the content data recommendation apparatus includes a first obtaining module 701, a first sending module 702, and a first receiving module 703. The first obtaining module 701 is configured to, in response to an operation for identity verification, obtain a first image of a user, and obtain attribute information of the user from the first image; the first sending module 702 is configured to send the attribute information obtained by the first obtaining module 701 to a content server, so that the content server determines first recommendation content data of the user according to the attribute information; and a first receiving module 703 is configured to receive the first recommendation content data fed back by the content server, and display recommendation content corresponding to the first recommendation content data.

In one embodiment, the apparatus further includes: an extracting module 704, configured to, after the identity verification module obtains the identity document information of the user, extract identity information of the user from the identity document information; a second sending module 705, configured to send the identity information to the content server, so that the content server determines second recommendation content data of the user according to the identity information; and a second receiving module 706, configured to receive the second recommendation content data fed back by the content server, and display recommendation content corresponding to the second recommendation content data.

In one embodiment, the apparatus further includes: a second obtaining module 707, configured to, in the process that the second receiving module displays the recommendation content corresponding to the second recommendation content data, obtain a second image of the user, and obtain facial expression information of the user from the second image; a third sending module 708, configured to send the facial expression information obtained by the second obtaining module 707 and the attribute information to the content server, so that the content server determines third recommendation content data of the user according to the facial expression information and the attribute information; and a third receiving module 709, configured to receive the third recommendation content data fed back by the content server, and display recommendation content corresponding to the third recommendation content data.

In one embodiment, the identity information includes at least one of: gender, age, registered residence, birth date, or astrological sign.

In one embodiment, the attribute information includes at least one of: skin color, hairstyle, whether glasses are worn, whether jewelry is worn, gender, age, hair color, or whether makeup is worn.

It should be noted that, the specific details further involved in the content data recommendation apparatus based on an identity verification apparatus provided in the embodiments of the present disclosure are described in detail in the content data recommendation method based on an identity verification apparatus provided in the embodiments of the present disclosure, and details are not described herein repeatedly.

### Embodiment VIII

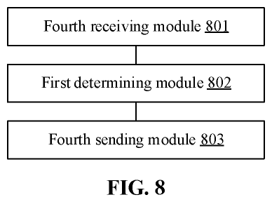

Based on a same technical concept, FIG. 8 is a schematic structural diagram of a content data recommendation apparatus based on an identity verification apparatus according to Embodiment VIII of the present disclosure. The flow of the content data recommendation method based on an identity verification apparatus according to Embodiment III may be executed.

With reference to FIG. 8, the content data recommendation apparatus includes a fourth receiving module 801, a first determining module 802, and a fourth sending module 803.

The fourth receiving module 801 is configured to receive attribute information of a user sent by a terminal device.

The first determining module 802 is configured to determine first recommendation content data of the user according to the attribute information received by the fourth receiving module 801.

The fourth sending module 803 is configured to push the first recommendation content data determined by the first determining module 802 to the terminal device.

By means of the content data recommendation apparatus provided in the present embodiment, attribute information of a user sent by a terminal device is received; first recommendation content data is determined according to the attribute information of the user; and then the determined first recommendation content data is pushed to the terminal device. Thus, precise content data can be recommended to the user.

### Embodiment IX

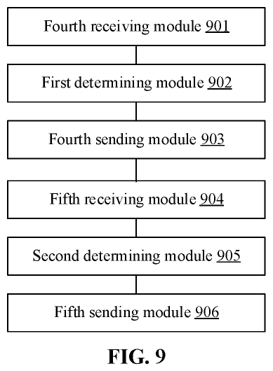

Based on a same technical concept, FIG. 9 is a schematic structural diagram of a content data recommendation apparatus based on an identity verification apparatus according to Embodiment IX of the present disclosure. The flow of the content data recommendation method based on an identity verification apparatus according to Embodiment IV may be executed.

With reference to FIG. 9, the content data recommendation apparatus includes a fourth receiving module 901, a first determining module 902, and a fourth sending module 903. The fourth receiving module 901 is configured to receive attribute information of a user sent by a terminal device; the first determining module 902 is configured to determine first recommendation content data of the user according to the attribute information received by the fourth receiving module 901; and the fourth sending module 903 is configured to push the first recommendation content data determined by the first determining module 902 to the terminal device.

In one embodiment, the first determining module 902 is configured to: match the attribute information with index information of multiple pieces of recommendation content data separately; obtain a matching score between the attribute information and the index information of each piece of recommendation content data by calculation based on a matching result; and determine the first recommendation content data according to the matching score.

In one embodiment, the apparatus further includes: a fifth receiving module 904, configured to, after the fourth receiving module receives the attribute information of the user sent by the terminal device, receive identity information of the user sent by the terminal device; a second determining module 905, configured to determine second recommendation content data of the user according to the identity information received by the fifth receiving module 904; and a fifth sending module 906, configured to push the second recommendation content data determined by the second determining module 905 to the terminal device.

In one embodiment, the second determining module 905 is configured to: match the identity information with index information of multiple pieces of recommendation content data; obtain a matching score between the identity information and the index information of each piece of recommendation content data by calculation based on a matching result; and determine the second recommendation content data according to the matching score.

It should be noted that, the specific details further involved in the content data recommendation apparatus based on an identity verification apparatus provided in the embodiments of the present disclosure are described in detail in the content data recommendation method based on an identity verification apparatus provided in the embodiments of the present disclosure, and details are not described herein repeatedly.

### Embodiment X

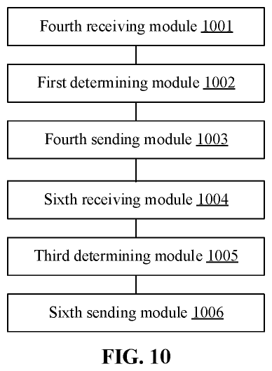

Based on a same technical concept, FIG. 10 is a schematic structural diagram of a content data recommendation apparatus based on an identity verification apparatus according to Embodiment X of the present disclosure. The flow of the content data recommendation method based on an identity verification apparatus according to Embodiment IV may be executed.

With reference to FIG. 10, the content data recommendation apparatus includes a fourth receiving module 1001, a first determining module 1002, and a fourth sending module 1003. The fourth receiving module 1001 is configured to receive attribute information of a user sent by a terminal device; the first determining module 1002 is configured to determine first recommendation content data of the user according to the attribute information received by the fourth receiving module 1001; and the fourth sending module 1003 is configured to push the first recommendation content data determined by the first determining module 1002 to the terminal device. In one embodiment, the apparatus further includes: a sixth receiving module 1004, configured to, after the fifth sending module pushes the second recommendation content data to the terminal device, receive facial expression information and attribute information of the user sent by the terminal device; a third determining module 1005, configured to determine third recommendation content data of the user according to the facial expression information and the attribute information received by the sixth receiving module 1004; and a sixth sending module 1006, configured to push the third recommendation content data determined by the third determining module 1005 to the terminal device.

In one embodiment, the third determining module 1005 is configured to: determine the type of the third recommendation content data according to the facial expression information; match the attribute information with index information of multiple pieces of recommendation content data of the determined type; obtain a matching score between the attribute information and the index information of each piece of recommendation content data of the determined type by calculation based on a matching result; and determine the third recommendation content data according to the matching score.

In one embodiment, the identity information includes at least one of: gender, age, registered residence, birth date, or astrological sign.

In one embodiment, the attribute information includes at least one of: skin color, hairstyle, whether glasses are worn, whether jewelry is worn, gender, age, hair color, or whether makeup is worn.

It should be noted that, the specific details further involved in the content data recommendation apparatus based on an identity verification apparatus provided in the embodiments of the present disclosure are described in detail in the content data recommendation method based on an identity verification apparatus provided in the embodiments of the present disclosure, and details are not described herein repeatedly.

### Embodiment XI

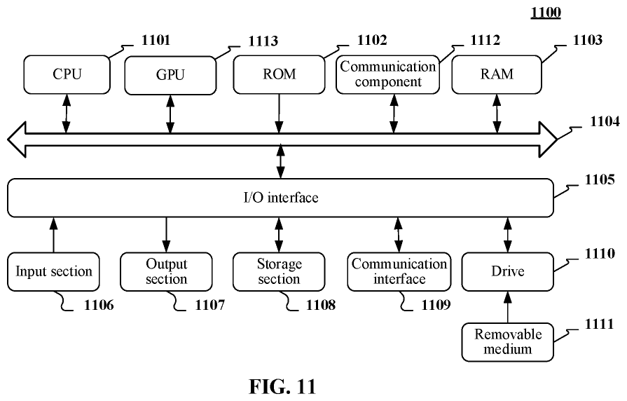

The embodiments of the present disclosure further provide an electronic device which, for example, may be a mobile terminal, a PC, a tablet computer, a server, or the like. Referring to FIG. 11 below, a schematic structural diagram of an electronic device 1100 suitable for implementing a terminal device or a server according to the embodiments of the present disclosure is shown. As shown in FIG. 11, the electronic device 1100 includes one or more first processors, a communication element, and the like. The one or more first processors are, for example, one or more Central Processing Units (CPUs) 1101 and/or one or more Graphic Processing Units (GPUs) 1113, and the first processors may execute various appropriate actions and processing according to executable instructions stored in a Read-Only Memory (ROM) 1102 or executable instructions loaded from a storage section 1108 to a Random Access Memory (RAM) 1103. In the present embodiment, the first ROM 1102 and the RAM 1103 are collectively referred to as a first memory. The communication element includes a communication component 1112 and/or a communication interface 1109. The communication component 1112 includes, but is not limited to, a network card, and the network card includes, but is not limited to, an InfiniBand (IB) network card. The communication interface 1109 includes a communication interface of a network interface card such as a Local Area Network (LAN) card and a modem, and the communication interface 1109 performs communication processing via a network such as the Internet.

The first processor may communicate with the ROM 1102 and/or the RAM 1103 to execute executable instructions, is connected to the communication component 1112 by means of a first communication bus 1104, and communicates with other target devices via the communication component 1112, so as to complete corresponding operations of any one of the content data recommendation methods based on an identity verification apparatus provided in the embodiments of the present disclosure, for example, in response to an operation for identity verification, obtaining a first image of a user, and obtaining attribute information of the user from the first image; sending the attribute information to a content server, so that the content server determines first recommendation content data of the user according to the attribute information; and receiving the first recommendation content data fed back by the content server, and displaying recommendation content corresponding to the first recommendation content data.

In addition, the RAM 1103 further stores various programs and data required for operations of an apparatus. The CPU 1101 or GPU 1113, the ROM 1102, and the RAM 1103 are connected to each other by means of the first communication bus 1104. In the presence of the RAM 1103, the ROM 1102 is an optional module. The RAM 1103 stores executable instructions, or writes the executable instructions to the ROM 1102 during running, where the executable instructions enable the first processor to perform corresponding operations of the foregoing communication method. An input/output (I/O) interface 1105 is also connected to the first communication bus 1104. The communication component 1112 is integrated, or is configured to have multiple sub-modules (for example, multiple IB network cards) linked on the communication bus.

The following components are connected to the I/O interface 1105: an input section 1106 including a keyboard, a mouse and the like; an output section 1107 including a Cathode-Ray Tube (CRT), a Liquid Crystal Display (LCD), a loudspeaker and the like; a storage section 1108 including hardware and the like; and the communication interface 1109 of a network interface card such as an LAN card and a modem. A drive 1110 is also connected to the I/O interface 1105 according to requirements. A removable medium 1111 such as a magnetic disk, an optical disk, a magneto-optical disk, a semiconductor memory or the like is installed on the drive 1110 according to requirements, so that a computer program read from the removable medium is installed on the storage section 1108 according to requirements.

It should be noted that, the architecture illustrated in FIG. 11 is merely an optional implementation. During specific practice, the number and types of the components in FIG. 11 may be selected, decreased, increased, or replaced according to actual requirements. Different functional components may be separated or integrated or the like. For example, the GPU and the CPU may be separated, or the GPU may be integrated on the CPU, and the communication element may be separated from or integrated on the CPU or the GPU or the like. These alternative implementations all fall within the scope of protection of the present disclosure.

Particularly, the process described above with reference to the flowchart according to the embodiments of the present disclosure may be implemented as a computer software program. For example, the embodiments of the present disclosure include a computer program product. The computer program product includes a computer program tangibly included in a machine-readable medium. The computer program includes a program code for executing the method shown in the flowchart. The program code may include corresponding instructions for executing the steps of the method provided in the embodiments of the present disclosure, for example, in response to an operation for identity verification, obtaining a first image of a user, and obtaining attribute information of the user from the first image; sending the attribute information to a content server, so that the content server determines first recommendation content data of the user according to the attribute information; and receiving the first recommendation content data fed back by the content server, and displaying recommendation content corresponding to the first recommendation content data. In such embodiments, the computer program may be downloaded and installed from a network through the communication element and/or installed from the removable medium 1111. When the computer program is executed by the first processor, the functions defined in the method according to the embodiments of the present disclosure are executed.

### Embodiment XII

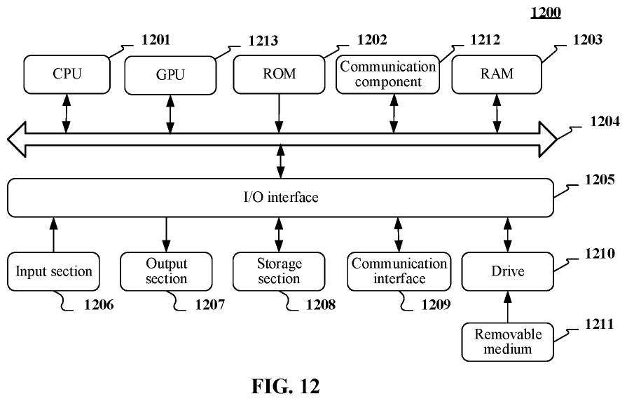

The embodiments of the present disclosure further provide an electronic device which, for example, may be a mobile terminal, a PC, a tablet computer, a server, or the like. Referring to FIG. 12 below, a schematic structural diagram of an electronic device 1200 suitable for implementing a terminal device or a server according to the embodiments of the present disclosure is shown. As shown in FIG. 12, the electronic device 1200 includes one or more second processors, a second communication element, and the like. The one or more second processors are, for example, one or more Central Processing Units (CPUs) 1201, and/or one or more Graphic Processing Units (GPUs) 1213, and the like. The second processors may perform various appropriate actions and processing according to executable instructions stored in a Read-Only Memory (ROM) 1202 or executable instructions loaded from a storage section 1208 to a Random Access Memory (RAM) 1203. In the present embodiment, the second ROM 1202 and the RAM 1203 are collectively referred to as a second memory. The second communication element includes a communication component 1212 and/or a communication interface 1209. The communication component 1212 may include, but is not limited to, a network card. The network card may include, but is not limited to, an InfiniBand (IB) network card. The communication interface 1209 includes a communication interface of a network interface card such as an LAN card and a modem, and the communication interface 1209 performs communication processing via a network such as the Internet.

The second processor may communicate with the ROM 1202 and/or the RAM 1203 to execute executable instructions, is connected to the communication component 1212 by means of a second communication bus 1204, and communicates with other target devices via the communication component 1212, so as to complete corresponding operations of any one of the content data recommendation methods based on an identity verification apparatus provided in the embodiments of the present disclosure, for example, receiving attribute information of a user sent by a terminal device; determining first recommendation content data of the user according to the attribute information; and pushing the first recommendation content data to the terminal device.

In addition, the RAM 1203 further stores various programs and data required for operations of an apparatus. The CPU 1201 or GPU 1213, the ROM 1202, and the RAM 1203 are connected to each other by means of the second communication bus 1204. In the presence of the RAM 1203, the ROM 1202 is an optional module. The RAM 1203 stores executable instructions, or writes the executable instructions to the ROM 1202 during running, where the executable instructions enable the second processor to perform corresponding operations of the foregoing communication method. An input/output (I/O) interface 1205 is also connected to the second communication bus 1204. The communication component 1212 is integrated, or is configured to have multiple sub-modules (for example, multiple IB network cards) linked on the communication bus.

The following components are connected to the I/O interface 1205: an input section 1206 including a keyboard, a mouse and the like; an output section 1207 including a Cathode-Ray Tube (CRT), a Liquid Crystal Display (LCD), a loudspeaker and the like; a storage section 1208 including hardware and the like; and the communication interface 1209 of a network interface card such as an LAN card and a modem. A drive 1210 is also connected to the I/O interface 1205 according to requirements. A removable medium 1211 such as a magnetic disk, an optical disk, a magneto-optical disk, a semiconductor memory or the like is installed on the drive 1210 according to requirements, so that a computer program read from the removable medium is installed on the storage section 1208 according to requirements.

It should be noted that, the architecture illustrated in FIG. 12 is merely an optional implementation. During specific practice, the number and types of the components in FIG. 12 may be selected, decreased, increased, or replaced according to actual requirements. Different functional components may be separated or integrated or the like. For example, the GPU and the CPU may be separated, or the GPU may be integrated on the CPU, and the communication element may be separated from or integrated on the CPU or the GPU or the like. These alternative implementations all fall within the scope of protection of the present disclosure.

Particularly, the process described above with reference to the flowchart according to the embodiments of the present disclosure may be implemented as a computer software program. For example, the embodiments of the present disclosure include a computer program product. The computer program product includes a computer program tangibly included in a machine-readable medium. The computer program includes a program code for executing the method shown in the flowchart. The program code may include corresponding instructions for executing the steps of the method provided in the embodiments of the present disclosure, for example, receiving attribute information of a user sent by a terminal device; determining first recommendation content data of the user according to the attribute information; and pushing the first recommendation content data to the terminal device. In such embodiments, the computer program may be downloaded and installed from a network through the communication element and/or installed from the removable medium 1211. When the computer program is executed by the second processor, the functions defined in the method according to the embodiments of the present disclosure are executed.

It should be noted that, according to requirements for implementation, the components/steps described in the embodiments of the present disclosure may be separated into more components/steps, and two or more components/steps or some operations of the components/steps may also be combined into new components/steps to achieve the purpose of the embodiments of the present disclosure.

The foregoing method according to the embodiments of the present disclosure may be implemented in hardware or firmware, or implemented as software or a computer code that can be stored in a recording medium (such as a CD ROM, a RAM, a floppy disk, a hard disk, or a magneto-optical disk), or implemented as a computer code that is downloaded by means of a network, is originally stored in a remote recording medium or a non-transitory machine-readable medium, and will be stored in a local recording medium. Therefore, the method described herein may be processed by using software that can be stored in a recording medium using a general-purpose computer, a special-purpose processor, or programmable or dedicated hardware (such as an ASIC or an FPGA). It may be understood that a computer, a processor, a microprocessor controller or programmable hardware includes a storage component (for example, a RAM, a ROM, or a flash memory) that can store or receive software or a computer code. When the software or the computer code is accessed and executed by the computer, the processor or the hardware, the processing method described herein is implemented. In addition, when the general-purpose computer accesses a code that is used for implementing processing shown herein, execution of the code converts the general-purpose computer to a special-purpose computer configured to execute the processing shown herein.

A person of ordinary skill in the art may be aware that, in combination with the examples described in the embodiments disclosed in the specification, units and method steps may be implemented by electronic hardware or a combination of computer software and electronic hardware. Whether these functions are performed by hardware or software depends on particular applications and design constraint conditions of the technical solutions. A person skilled in the art may use different methods to implement the described functions for each particular application, but it should not be considered that this implementation goes beyond the scope of the embodiments of the present disclosure.

The foregoing implementations are merely intended to describe the embodiments of the present disclosure rather than limit the embodiments of the present disclosure. A person of ordinary skill in the art may make modifications and variations without departing from the spirit and scope of the embodiments of the present disclosure. Therefore, all equivalent technical solutions shall also fall within the scope of the embodiments of the present disclosure, and the patent protection scope of the embodiments of the present disclosure shall be subject to the claims.

1. A content data recommendation method based on an identity verification apparatus, comprising:
in response to an operation for identity verification, obtaining a first image of a user, and obtaining attribute information of the user from the first image;
sending the attribute information to a content server, so that the content server determines first recommendation content data of the user according to the attribute information; and
receiving the first recommendation content data fed back by the content server, and displaying recommendation content corresponding to the first recommendation content data.

2. The method according to claim 1, further comprising: when obtaining the first image of the user,
obtaining identity document information of the user; and
performing identity verification according to the first image and the identity document information to obtain a result of the identity verification.

3. The method according to claim 2, wherein the obtaining identity document information of the user comprises:
recognizing information in an identity document chip by means of a card reader, and obtaining the identity document information of the user based on the information in the identity document chip.

4. The method according to claim 2, wherein the obtaining identity document information of the user comprises:
recognizing image information in an identity document image by means of an Optical Character Recognition (OCR) module, and obtaining the identity document information of the user based on the image information.

5. The method according to claim 2, further comprising: after obtaining the identity document information of the user,
extracting identity information of the user from the identity document information;
sending the identity information to the content server, so that the content server determines second recommendation content data of the user according to the identity information; and
receiving the second recommendation content data fed back by the content server, and displaying recommendation content corresponding to the second recommendation content data.

6. The method according to claim 5, further comprising: in the process of displaying recommendation content corresponding to the second recommendation content data,
obtaining a second image of the user, and obtaining facial expression information of the user from the second image;
sending the facial expression information and the attribute information to the content server, so that the content server determines third recommendation content data of the user according to the facial expression information and the attribute information; and
receiving the third recommendation content data fed back by the content server, and displaying recommendation content corresponding to the third recommendation content data.

7. The method according to claim 5, wherein the identity information comprises at least one of: gender, age, registered residence, birth date, or astrological sign. 25

8. The method according to claim 1, wherein the attribute information comprises at least one of: skin color, hairstyle, whether glasses are worn, whether jewelry is worn, gender, age, hair color, or whether makeup is worn.

9. A content data recommendation method based on an identity verification apparatus, comprising:
receiving attribute information of a user sent by a terminal device;
determining first recommendation content data of the user according to the attribute information; and
pushing the first recommendation content data to the terminal device.

10. The method according to claim 9, wherein the determining first recommendation content data of the user according to the attribute information comprises:
matching the attribute information with index information of multiple pieces of recommendation content data separately;
obtaining a matching score between the attribute information and the index information of each piece of recommendation content data by calculation based on a matching result; and
determining the first recommendation content data according to the matching score.

11. The method according to claim 9, further comprising: after receiving the attribute information of the user sent by the terminal device,
receiving identity information of the user sent by the terminal device;
determining second recommendation content data of the user according to the identity information; and
pushing the second recommendation content data to the terminal device.

12. The method according to claim 11, wherein the determining second recommendation content data of the user according to the identity information comprises:
matching the identity information with index information of multiple pieces of recommendation content data;
obtaining a matching score between the identity information and the index information of each piece of recommendation content data by calculation based on a matching result; and
determining the second recommendation content data according to the matching score.

13. The method according to claim 11, further comprising: after pushing the second recommendation content data to the terminal device,
receiving facial expression information and attribute information of the user sent by the terminal device;
determining third recommendation content data of the user according to the facial expression information and the attribute information; and
pushing the third recommendation content data to the terminal device.

14. The method according to claim 13, wherein the determining third recommendation content data of the user according to the facial expression information and the attribute information comprises:
determining a type of the third recommendation content data according to the facial expression information;
matching the attribute information with index information of multiple pieces of recommendation content data of the determined type;
obtaining a matching score between the attribute information and the index information of each piece of recommendation content data of the determined type by calculation based on a matching result; and
determining the third recommendation content data according to the matching score.

15. The method according to claim 11, wherein the identity information comprises at least one of: gender, age, registered residence, birth date, or astrological sign.

16. The method according to claim 9, wherein the attribute information comprises at least one of: skin color, hairstyle, whether glasses are worn, whether jewelry is worn, gender, age, hair color, or whether makeup is worn.

17. A content data recommendation apparatus based on an identity verification apparatus, comprising:
a memory storing processor-executable instructions; and
a processor arranged to execute the stored processor-executable instructions to perform steps of:
in response to an operation for identity verification, obtaining a first image of a user, and obtain attribute information of the user from the first image;
sending the attribute information obtained by the first obtaining module to a content server, so that the content server determines first recommendation content data of the user according to the attribute information; and
receiving the first recommendation content data fed back by the content server, and displaying recommendation content corresponding to the first recommendation content data.

18. The apparatus according to claim 17, wherein the processor arranged to execute the stored processor-executable instructions to further perform steps of: when obtaining the first image of the user,
obtaining identity document information of the user; and performing identity verification according to the first image and the identity document information to obtain a result of the identity verification.

19. A content data recommendation apparatus based on an identity verification apparatus, comprising:
a memory storing processor-executable instructions; and
a processor arranged to execute the stored processor-executable instructions to perform steps of the method according to claim 9.

20. A non-transitory computer-readable storage medium having stored thereon computer program instructions that, when executed by a processor, cause the processor to implement steps of the content data recommendation method based on an identity verification apparatus according to claim 1.
